(19) United States
(12) Patent Application Publication
(10) Pub. No.: US 2023/0402875 A1
(43) Pub. Date: Dec. 14, 2023

(54) UNDERWATER POWER SUPPLY SYSTEM AND POWER-RECEIVING DEVICE

(71) Applicant: PANASONIC HOLDINGS CORPORATION, Osaka (JP)

(72) Inventor: Tatsuo YAGI, Fukuoka (JP)

(73) Assignee: PANASONIC HOLDINGS CORPORATION, Osaka (JP)

(21) Appl. No.: 18/034,209

(22) PCT Filed: Oct. 29, 2021
(86) PCT No.: PCT/JP2021/040177

§ 371 Date: Apr. 27, 2023

(30) Foreign Application Priority Data
Oct. 30, 2020 (JP) 2020-183275

(51) Int. Cl. H02J 50/12; B63G 8/00; B60L 53/30; B60L 53/20; B60L 53/12

(52) U.S. Cl. CPC H02J 50/12; B63G 8/001; B60L 53/30; B60L 53/20; B60L 2200/32; B63G 2008/004; B63G 2008/005; B60L 2210/10; B60L 53/12

(57) ABSTRACT

A power transmission device includes a power transmission coil, and a power transmission side processor. A power reception device includes a power reception coil receiving electric power from the power transmission coil, a power reception power supply charging the storage battery based on the received electric power and general-purpose power supply components, a power reception side processor periodically controlling a charging current to the storage battery, and a current sensor detecting the charging current. When a value of the charging current is outside a predetermined range, the power reception side processor calculates a feedback control parameter to the power transmission power supply based on a difference between the value of the charging current and a target current value, and transmits the feedback control parameter to the power transmission side processor. The power transmission side processor controls electric power from the power transmission power supply based on the feedback control parameter.

### TECHNICAL FIELD

The present disclosure relates to an underwater power supply system and a power reception device for receiving electric power to charge a storage battery underwater.

### BACKGROUND ART

Patent Literature 1 discloses a wireless power transmission apparatus including: an information acquisition unit configured to execute at least one of a process of acquiring transmission power information from a power transmission unit and a process of acquiring reception power information from a power reception unit configured to receive electric power transmitted from the power transmission unit; and a control unit capable of executing a plurality of processes among a process of adjusting power transmission of the power transmission unit according to the transmission power information, a process of adjusting impedance of the power reception unit according to the transmission power information, a process of adjusting power transmission of the power transmission unit according to the reception power information, and a process of adjusting the impedance of the power reception unit according to the reception power information, and the control unit being configured to switch between the plurality of processes to select one based on a predetermined condition and execute the selected process.

### CITATION LIST

### Patent Literature

Patent Literature 1: WO2015/001672

### SUMMARY OF INVENTION

### Technical Problem

In Patent Literature 1, it is not assumed that a load including a power reception unit moves underwater (for example, in the sea) or electric power is transmitted from a power transmission unit to a power reception unit of a load underwater. In recent years, an undersea power supply system has been proposed that, from a power transmission device of a ship or the like that is moored on the water such as on the sea, charges a storage battery (rechargeable battery) built in a power reception device, which is movable under the water such as under the sea, with charging electric power received by the power reception device from the power transmission device. In the undersea power supply system, since a general-purpose charging power supply is not present, a customized power supply is required for the undersea power supply. But if a charging power supply can be implemented by feedback control using a power supply in which a plurality of general-purpose DC/DC converters and the like are combined (hereinafter, referred to as a “stack DC/DC power supply”), it is possible to achieve various charging configurations and specifications by a combination of power supplies, and the cost in constructing a system can be greatly reduced. This implementation method is considered to be a useful method.

However, when the feedback control using the stack DC/DC power supply is performed in a power reception system, an operating delay of a feedback system (that is, components related to the feedback control. The same applies to the following) occurs depending on a variation in performance of the stack DC/DC power supply, a state of the storage battery, a charging current, and the like. Therefore, there is a problem that an operation of undersea power supply is not stable unless the feedback control is performed in consideration of a cause of the occurrence of the delay.

The present disclosure has been proposed in view of the above-described circumstances in the related art, and provides an underwater power supply system and a power reception device that stably control charging of a storage battery built in a power reception system following an operating delay of a feedback system when a stack DC/DC power supply is employed in the power reception system.

### Solution to Problem

The present disclosure provides an underwater power supply system including a power transmission device and a power reception device, the power reception device being capable of moving underwater. The power transmission device includes a power transmission coil configured to transmit electric power to the power reception device via a magnetic field, and a power transmission side processor configured to control the electric power from a power transmission power supply and supply the electric power to the power transmission coil. The power reception device includes: a power reception coil configured to receive electric power from the power transmission coil; a power reception power supply including a plurality of general-purpose power supply components and a storage battery, and configured to charge the storage battery based on the electric power received by the power reception coil and based on the plurality of general-purpose power supply components; a power reception side processor configured to periodically control a charging current to the storage battery; and a current sensor configured to detect the charging current. When it is determined that a value of the detected charging current is a current value outside a predetermined range, the power reception side processor calculates a feedback control parameter to the power transmission power supply based on a difference between the value of the charging current and a target current value, and transmits the feedback control parameter to the power transmission side processor. The power transmission side processor controls electric power from the power transmission power supply based on the feedback control parameter.

Further, the present disclosure provides an underwater power supply system including a power transmission device and a power reception device, the power reception device being capable of moving underwater. The power transmission device includes a power transmission coil configured to transmit electric power to the power reception device via a magnetic field, and a power transmission side processor configured to control the electric power from a power transmission power supply and supply the electric power to the power transmission coil. The power reception device includes: a power reception coil configured to receive electric power from the power transmission coil; a power reception power supply including a plurality of general-purpose power supply components and a storage battery, and configured to charge the storage battery based on the electric power received by the power reception coil and based on the plurality of general-purpose power supply components; a power reception side processor configured to periodically control a charging current to the storage battery; and a current sensor configured to detect the charging current. When it is determined that a value of the detected charging current is a current value outside a predetermined range, the power reception side processor calculates a feedback control parameter to the power reception power supply based on a difference between the value of the charging current and a target current value. The power reception power supply controls the charging current to the storage battery based on the feedback control parameter to charge the storage battery.

Further, the present disclosure provides a power reception device that is capable of moving underwater and that receives electric power transmitted from a power transmission device including a power transmission coil, the power reception device including: a power reception coil configured to receive electric power from the power transmission coil; a power reception power supply including a plurality of general-purpose power supply components and a storage battery, and configured to charge the storage battery based on the electric power received by the power reception coil and based on the plurality of general-purpose power supply components; a power reception side processor configured to periodically control a charging current to the storage battery; and a current sensor configured to detect the charging current. When it is determined that a value of the detected charging current is a current value outside a predetermined range, the power reception side processor calculates a feedback control parameter to a power transmission power supply based on a difference between the value of the charging current and a target current value, and instructs, to the power transmission device, power control from the power transmission power supply based on the feedback control parameter.

Further, the present disclosure provides a power reception device that is capable of moving underwater and that receives electric power transmitted from a power transmission device including a power transmission coil, the power reception device including: a power reception coil configured to receive electric power from the power transmission coil; a power reception power supply including a plurality of general-purpose power supply components and a storage battery, and configured to charge the storage battery based on the electric power received by the power reception coil and based on the plurality of general-purpose power supply components; a power reception side processor configured to periodically control a charging current to the storage battery; and a current sensor configured to detect the charging current. When it is determined that a value of the detected charging current is a current value outside a predetermined range, the power reception side processor calculates a feedback control parameter to the power reception power supply based on a difference between the value of the charging current and a target current value. The power reception power supply controls the charging current to the storage battery based on the feedback parameter to charge the storage battery.

### ADVANTAGEOUS EFFECTS OF INVENTION

According to the present disclosure, when a stack DC/DC power supply is employed in a power reception system, it is possible to stably control charging of a storage battery built in the power reception system following an operating delay of a feedback system.

### BRIEF DESCRIPTION OF DRAWINGS

FIG. 1 is a diagram schematically illustrating an example of a usage environment in which an underwater power supply system according to an embodiment is installed.

FIG. 2 is a diagram illustrating a hardware configuration example of the underwater power supply system according to the present embodiment.

FIG. 3 is a block diagram illustrating a configuration example of a power reception side processor corresponding to a feedback control route 1.

FIG. 4 is a block diagram illustrating a configuration example of the power reception side processor corresponding to a feedback control route 2.

FIG. 5 is a flowchart illustrating an example of an operation procedure of a power reception side processor according to the present embodiment.

FIG. 6 is a flowchart illustrating an example of an operation procedure of the power reception side processor according to the present embodiment.

FIG. 7 is a flowchart illustrating an example of an operation procedure of a delay re-measurement determination process in FIG. 5.

FIG. 8 is a graph illustrating an example of transition of a current value of a charging current detected for each periodic interrupt process.

FIG. 9 is a graph illustrating an example of an experimental result of stability of a charging current in a case where an estimated delay time interval is set to 40 ms.

FIG. 10 is a graph illustrating an example of an experimental result of stability of a charging current in a case where an estimated delay time interval is 50 ms.

FIG. 11 is a graph illustrating an example of an experimental result of stability of a charging current in a case where an estimated delay time interval is 60 ms.

### DESCRIPTION OF EMBODIMENTS

### Background of Present Embodiment

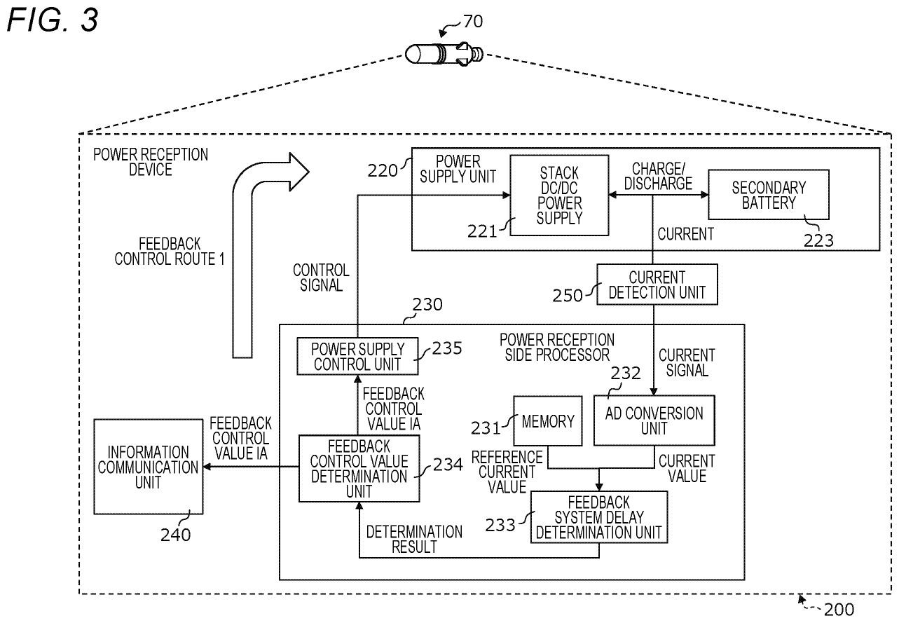

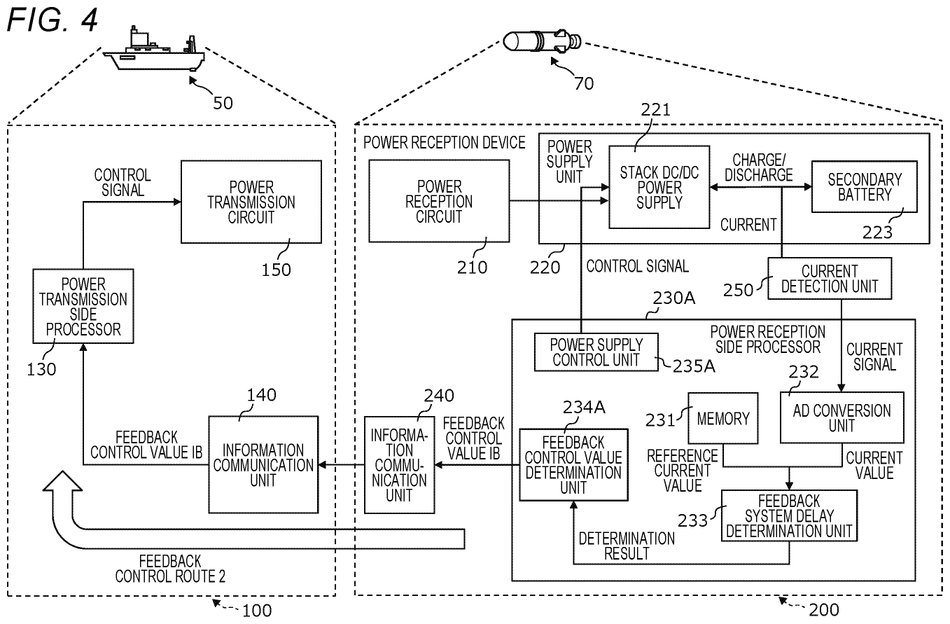

As described above, in undersea power supply in the related art, when feedback control employing a stack DC/DC power supply is performed in a power reception system, an operating delay of a feedback system (that is, components related to the feedback control) occurs depending on a variation in performance of the stack DC/DC power supply, a state of a storage battery, a charging current, and the like. Therefore, there is a problem that an operation of undersea power supply is not stable unless the feedback control is performed in consideration of a cause of the occurrence of the delay. Here, as a feedback control method, a feedback control route 1 (see FIG. 3) and a feedback control route 2 (see FIG. 4) are considered. When charging control of the storage battery built in the power reception system is taken into consideration, both of the feedback control routes 1 and 2 can be executed. However, when the stack DC/DC power supply is employed in the power reception system, charging efficiency using the stack DC/DC power supply depends on a primary voltage (that is, the transmission power) of a primary side (that is, a power transmission system). Therefore, when the overall power supply efficiency of systems in undersea power supply is taken into consideration, it is conceivable that the feedback control route 2 is more excellent in power supply efficiency than the feedback control route 1.

However, since the feedback control route 2 involves coils on a power transmission side and a power reception side in the feedback control, there is a high possibility that an operating delay of the feedback system (for example, an operating delay based on a variation in the charging current and a variation in impedance) is larger than that in the feedback control route 1. For this reason, in implementing the feedback control route 2, a mechanism for detecting the operating delay of the feedback system and updating delay information is more necessary than in implementing the feedback control route 1. In addition, it is known that impedance of the storage battery at the time of charging is a very small value in any of the feedback control routes 1 and 2. For this reason, if the charging current cannot be controlled accurately in the power reception system, it is difficult to stably control the charging current.

In view of the above, in the present embodiment described below, an example of an underwater power supply system and a charging control device will be described that stably control charging of a storage battery built in a power reception system following an operating delay of a feedback system when a stack DC/DC power supply is employed in the power reception system.

### Present Embodiment

Hereinafter, an embodiment in which an underwater power supply system and a charging control device according to the present disclosure are specifically disclosed (hereinafter referred to as “the present embodiment”) will be described in detail with reference to the drawings as appropriate. An unnecessarily detailed description may be omitted. For example, a detailed description of well-known matters and a redundant description of substantially the same configuration may be omitted. This is to avoid the following description from being unnecessarily redundant and facilitate understanding of those skilled in the art. The accompanying drawings and the following description are provided for those skilled in the art to fully understand the present disclosure, and are not intended to limit the subject matters described in the claims.

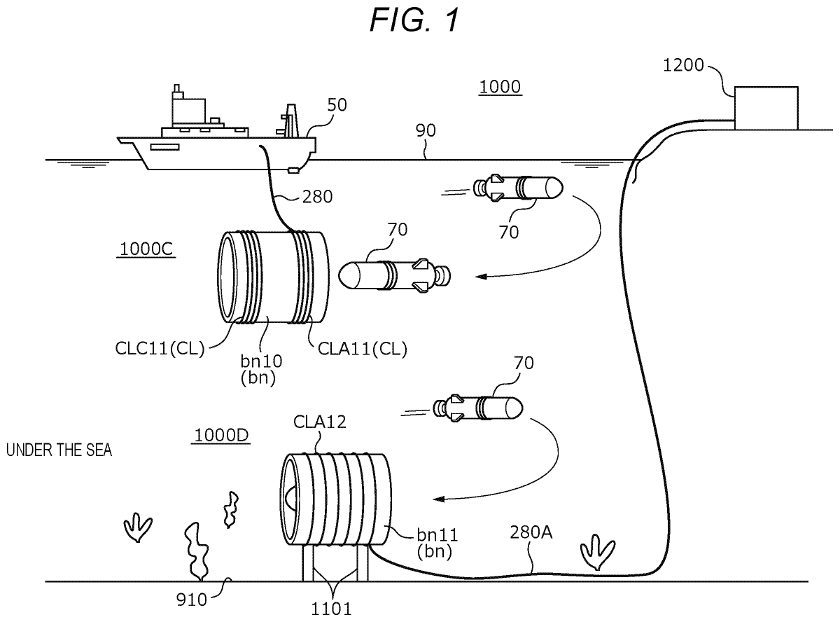

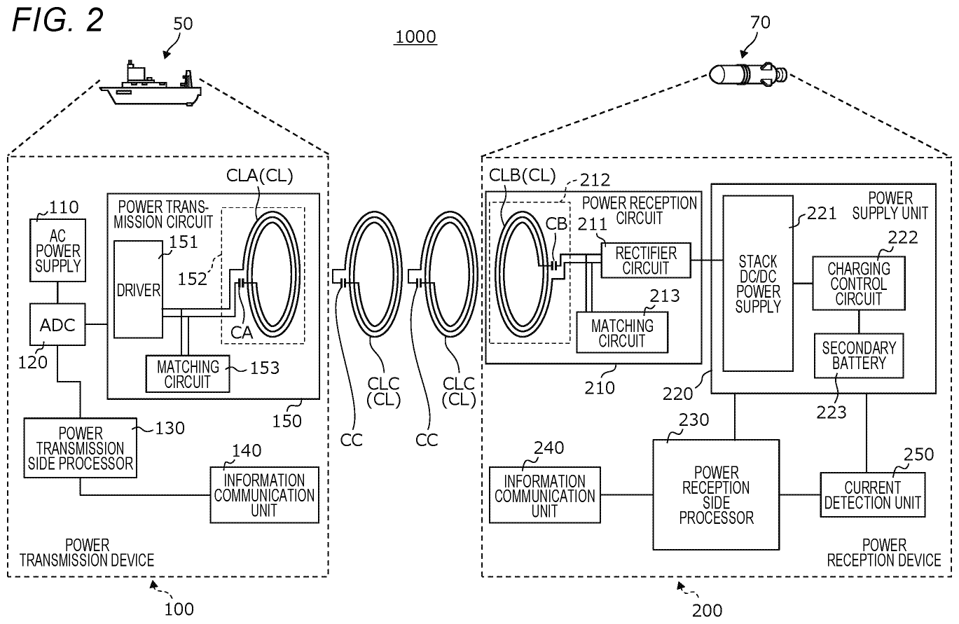

FIG. 1 is a diagram schematically illustrating an example of a usage environment in which an underwater power supply system 1000 according to the present embodiment is installed. The underwater power supply system 1000 includes a power transmission device 100, a power reception device 200, and a plurality of coils CL (see FIG. 2). The power transmission device 100 transmits electric power to the power reception device 200 via the plurality of coils CL in a wireless manner (that is, contactless) in accordance with a magnetic resonance method. The number of coils CL to be arranged is n (n: an integer equal to or greater than 2), and is freely set.

The coil CL is formed in an annular shape, for example, and is insulated by being covered with a resin cover. The coil CL is formed of, for example, a cabtyre cable, a helical coil, or a spiral coil. The helical coil is an annular coil wound in a helical shape along a transmission direction of electric power according to the magnetic resonance method, not in the same plane. The spiral coil is an annular coil formed in a spiral shape in the same plane. By adopting the spiral coil, it is possible to reduce a thickness of the coil CL. By adopting the helical coil, it is possible to secure a wide space inside the wound coil CL. FIG. 1 illustrates an example of the spiral coil.

The coil CL used for power transmission includes a power transmission coil CLA and a power reception coil CLB. The power transmission coil CLA is a primary coil. The power reception coil CLB is a secondary coil. The coil CL may include at least one relay coil CLC (Booster Coil) disposed between the power transmission coil CLA and the power reception coil CLB. The relay coil CLC is an example of the power transmission coil. When there are a plurality of relay coils CLC, the individual relay coils CLC are arranged substantially parallel to each other, and half or more of opening surfaces formed by the relay coils CLC overlap each other. An interval between the plurality of relay coils CLC is, for example, equal to or greater than a radius of the relay coil CLC. The relay coil CLC assists power transmission of the power transmission coil CLA.

The power transmission coil CLA is provided in the power transmission device 100 (see FIG. 2). The power reception coil CLB is provided in the power reception device 200 (see FIG. 2). The relay coil CLC may be provided in the power transmission device 100, may be provided in the power reception device 200, or may be provided separately from the power transmission device 100 and the power reception device 200. A part of the relay coil CLC may be provided in the power transmission device 100, and another part thereof may be provided in the power reception device 200.

A part of the power transmission device 100 may be installed in a ship 50, or may be arranged in another part (for example, a power supply facility 1200 installed on land). The power reception device 200 may be set in a movable underwater sailing body 70 (for example, an underwater vehicle or a water bottom excavator), or may be installed in an underwater facility (for example, a seismograph, a monitoring camera, or a geothermal power generator) that is fixedly installed. In FIG. 1, an underwater vehicle is illustrated as an example of the underwater sailing body 70. Each coil CL is disposed underwater (for example, undersea).

The underwater sailing body 70 may be, for example, a remotely operated vehicle (ROV), an unmanned underwater vehicle (UUV), or an autonomous underwater vehicle (AUV).

A part of the ship 50 is present above a water surface 90 (for example, a sea surface), that is, on the water, and another part of the ship 50 is present below the water surface 90, that is, underwater (for example, undersea). The ship 50 is movable on the water (for example, on the sea), and can freely move to, for example, a water surface (for example, a sea surface) of a data acquisition place. The power transmission device 100 installed in the ship 50 and the power transmission coil CLA are connected by a power cable 280. The power cable 280 is connected to a driver 151 (see FIG. 2) in the power transmission device 100 via a connector located above the water surface.

The underwater sailing body 70 is navigated underwater, and is capable of moving freely to a predetermined data acquisition point based on an instruction from the ship 50. The instruction from the ship 50 may be transmitted by communication via the coils CL, or may be transmitted by another communication method.

The coils CL are arranged at regular intervals, for example. A distance (coil interval) between the adjacent coils CL is, for example, 5 m. The coil interval is, for example, a length about a half of the diameter of the coil CL. A transmission frequency is, for example, kHz or lower in consideration of the amount of attenuation of a magnetic field strength under the water (for example, under the sea), and is preferably lower than 10 kHz. In a case of power transmission performed at a transmission frequency of 10 kHz or higher, a predetermined simulation needs to be performed based on provisions of the Radio Law, and in a case of power transmission performed at a transmission frequency lower than 10 kHz, the operation can be omitted. As the transmission frequency decreases, a power transmission distance increases, the coil CL increases in size, and the coil interval increases. The transmission frequency may be, for example, a frequency higher than 40 kHz when a communication signal is superimposed.

The transmission frequency is determined based on coil characteristics such as inductance of the coil CL, the diameter of the coil CL, and the number of turns of the coil CL. The diameter of the coil CL is, for example, several meters to several tens of meters. In addition, as the thickness of the coil CL increases, that is, as a wire diameter of the coil CL increases, electric resistance in the coil CL decreases, and power loss decreases. In addition, electric power transmitted via the coil CL is, for example, 50 W or more, and may be in the order of kW.

The power transmission device 100 may include one or more bobbins bn around which a wire of the coil is wound. As a material of the bobbin bn, a nonconductive or weakly magnetic material (for example, a resin such as polyvinyl chloride, acryl, or polyester) is used. The material of the bobbin bn may have a dielectric property. For example, in a case of using the polyvinyl chloride as the material of the bobbin bn, the polyvinyl chloride is easily available at low cost and is easily processed. Since the bobbin bn is nonconductive, in the power transmission device 100, a magnetic field generated by an alternating current flowing through the coil CL can be suppressed from being absorbed by the bobbin bn. In FIG. 1, in order to perform underwater power supply (for example, undersea power supply), a power supply stand including a bobbin bn10 floating underwater and a power supply stand including a bobbin bn11 disposed on a sea bottom are installed.

In the power supply stand including the bobbin bn10, a power transmission coil CLA11 and a relay coil CLC11 are wound around an outer periphery of the cylindrical bobbin bn10. The power cable 280 is connected to the power transmission coil CLA11, and electric power is supplied from the ship 50 moored on the sea via the power cable 280. The power cable 280 supports the power supply stand in a floating state under the sea. In the floating state, openings on both sides of the cylindrical bobbin bn10 may face a horizontal direction. The underwater sailing body 70 may make an entry in the horizontal direction from an entrance of the power supply stand in a floating state, and stay inside the bobbin bn10 to receive power.

The power supply stand including the bobbin bn11 is fixed to upper portions of two support columns 1101 embedded in a sea bottom 910. The entrance of the power supply stand may face the horizontal direction. In the power supply stand, the power transmission coil CLA12 is wound around the cylindrical bobbin bn11, but the relay coil CLC is not disposed. For example, a power cable 280A laid along the sea bottom 910 may be connected to the power transmission coil CLA12, and electric power may be supplied from the power supply facility 1200 via the power cable 280A. The underwater sailing body 70 may make an entry in the horizontal direction from an entrance of the power supply stand installed in the sea bottom 910 and stay inside the bobbin bn11 to receive power.

FIG. 2 is a diagram illustrating a hardware configuration example of the underwater power supply system 1000 according to the present embodiment. As described above, the underwater power supply system 1000 includes the power transmission device 100, the power reception device 200, and the plurality of coils CL.

The power transmission device 100 includes an AC power supply 110, an AC/DC converter (ADC) 120, a power transmission side processor 130, an information communication unit 140, and a power transmission circuit 150.

The ADC 120 converts AC power supplied from the AC power supply 110, which is an example of a power transmission power supply, into DC power. The converted DC power is transmitted to the power transmission circuit 150.

The power transmission side processor 130 is implemented using, for example, a central processing unit (CPU), and performs overall control over operations of the units (for example, the AC power supply 110, the ADC 120, the information communication unit 140, and the power transmission circuit 150) of the power transmission device 100.

The information communication unit 140 includes a modulation/demodulation circuit for modulating or demodulating communication data communicated with the power reception device 200. For example, the information communication unit 140 transmits, via the coil CL, control information to be transmitted from the power transmission device 100 to the power reception device 200. For example, the information communication unit 140 receives, via the coil CL, data to be transmitted from the power reception device 200 to the power transmission device 100. The data includes, for example, data of an exploration result obtained by underwater exploration or water bottom exploration performed by the underwater sailing body 70, or a feedback control parameter (for example, a feedback control value IB) calculated by the power reception device 200. The information communication unit 140 can rapidly perform data communication with the underwater sailing body 70 (in other words, the power reception device 200) while the underwater sailing body 70 is performing work such as data collection.

The power transmission circuit 150 includes the driver 151, a resonance circuit 152, and a matching circuit 153. The driver 151 converts the DC power from the ADC 120 into an AC voltage (for example, a pulse waveform) of a predetermined frequency. The resonance circuit 152 includes a capacitor CA and the power transmission coil CLA, and generates an AC voltage having a sinusoidal waveform from the AC voltage having a pulse waveform from the driver 151. The power transmission coil CLA resonates at a predetermined resonance frequency according to the AC voltage applied from the driver 151. The power transmission coil CLA is subjected to impedance matching with output impedance of the power transmission device 100 by the matching circuit 153.

A frequency of the AC voltage obtained by the conversion of the driver 151 corresponds to the transmission frequency of the power transmission between the power transmission device 100 and the power reception device 200, and corresponds to the resonance frequency. The transmission frequency may be set based on, for example, a Q value of each coil CL.

The power reception device 200 includes a power reception circuit 210, a power supply unit 220, a power reception side processor 230, an information communication unit 240, and a current detection unit 250.

The power reception circuit 210 includes a rectifier circuit 211, a resonance circuit 212, and a matching circuit 213. The rectifier circuit 211 converts AC power induced in the power reception coil CLB into DC power. The resonance circuit 212 includes a capacitor CB and the power reception coil CLB, and receives the AC power transmitted from the power transmission coil CLA. The power reception coil CLB is subjected to impedance matching with input impedance of the power reception device 200 by the matching circuit 213.

The power supply unit 220 serving as an example of a power reception power supply includes a stack DC/DC power supply 221, a charging control circuit 222, and a secondary battery 223 serving as an example of a storage battery. As a power supply for charging the secondary battery 223 in the underwater power supply system 1000, the stack DC/DC power supply 221 constitutes a power supply circuit in which a plurality of DC/DC converters, which are general-purpose circuit components (an example of general-purpose power supply components), are combined, and based on a control signal (see FIG. 3) from the power reception side processor 230, supplies the DC power from the power reception circuit 210 to the charging control circuit 222 after, for example, stepping up or stepping down the DC power. The charging control circuit 222 controls charging of the secondary battery 223 according to a type of the secondary battery 223. For example, the charging control circuit 222 starts charging the secondary battery 223 at a constant voltage based on the DC power from the stack DC/DC power supply 221. The secondary battery 223 stores the electric power transmitted from the power transmission device 100. The secondary battery 223 is, for example, a lithium ion battery.

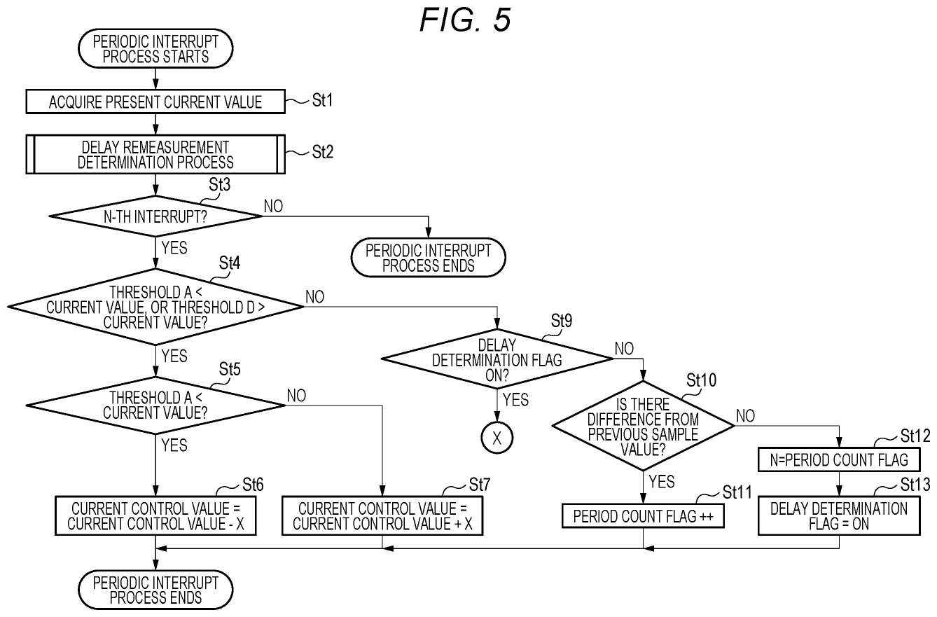

Power reception side processors 230 and 230A are implemented using, for example, a CPU, and exercises control over operations of the units (for example, the power reception circuit 210, the power supply unit 220, the current detection unit 250, and the information communication unit 240) of the power reception device 200. The power reception side processors 230 and 230A perform a periodic interrupt process for periodically controlling a charging current to the secondary battery 223 (see FIGS. 5 to 7). The periodic interrupt process is executed every 10 ms, for example, but is periodically executed at each delay time interval obtained as a delay measurement result when a delay time is measured as described later. Details of the power reception side processors 230 and 230A will be described later with reference to FIG. 3 or FIG. 4.

The information communication unit 240 includes a modulation/demodulation circuit for modulating or demodulating communication data communicated with the power transmission device 100. For example, the information communication unit 240 receives, via the coil CL, control information to be transmitted from the power transmission device 100 to the power reception device 200. For example, the information communication unit 240 transmits, via the coil CL, data to be transmitted from the power reception device 200 to the power transmission device 100. The data includes, for example, the feedback control parameter (for example, the feedback control value IB) calculated by the power reception device 200 or the data of the exploration result obtained by underwater exploration or water bottom exploration performed by the underwater sailing body 70. The information communication unit 240 can rapidly perform data communication with the ship 50 (in other words, the power transmission device 100) while the underwater sailing body 70 is performing work such as data collection.

The current detection unit 250 serving as an example of a current sensor detects a current (that is, a charging current) to the secondary battery 223 of the power supply unit 220 and transmits the detected current to the power reception side processors 230 and 230A.

Similarly to the power transmission coil CLA and the power reception coil CLB, the relay coil CLC forms a resonance circuit together with a capacitor CC. That is, in the present embodiment, since the resonance circuits are arranged in multiple stages under the water, electric power is transmitted by the magnetic resonance method.

Here, the power transmission from the power transmission device 100 to the power reception device 200 will be briefly described with reference to FIG. 2.

In the resonance circuit 152 of the power transmission device 100, when a current flows through the power transmission coil CLA of the power transmission device 100, a magnetic field is generated around the power transmission coil CLA. Vibration of the generated magnetic field is transmitted to the resonance circuit including the relay coil CLC that resonates at the same frequency as the resonance frequency in the resonance circuit 152.

In the resonance circuit including the relay coil CLC, a current is excited in the relay coil CLC by the vibration of the magnetic field and the current flows, and a magnetic field is further generated around the relay coil CLC. Vibration of the generated magnetic field is transmitted to the resonance circuit including the other relay coils CLC, which resonate at the same frequency as the resonance frequency in the resonance circuit 152, and to the resonance circuit 212 including the power reception coil CLB.

In the resonance circuit 212 of the power reception device 200, an alternating current is induced in the power reception coil CLB by the vibration of the magnetic field of the relay coil CLC. The induced alternating current is rectified by the rectifier circuit 211 and is converted into a predetermined voltage in the power supply unit 220, and a charging current flows, whereby the secondary battery 223 is charged.

Next, a configuration example of the power reception side processor 230 according to the feedback control 1 will be described with reference to FIG. 3. The feedback control route 1 performs feedback control such that the charging current to the secondary battery 223 is set to a target current value by the power reception device 200 alone, which is a secondary side. FIG. 3 is a block diagram illustrating the configuration example of the power reception side processor 230 corresponding to the feedback control route 1. The power reception side processor 230 includes a memory 231, an AD conversion unit 232, a feedback system delay determination unit 233, a feedback control value determination unit 234, and a power supply control unit 235.

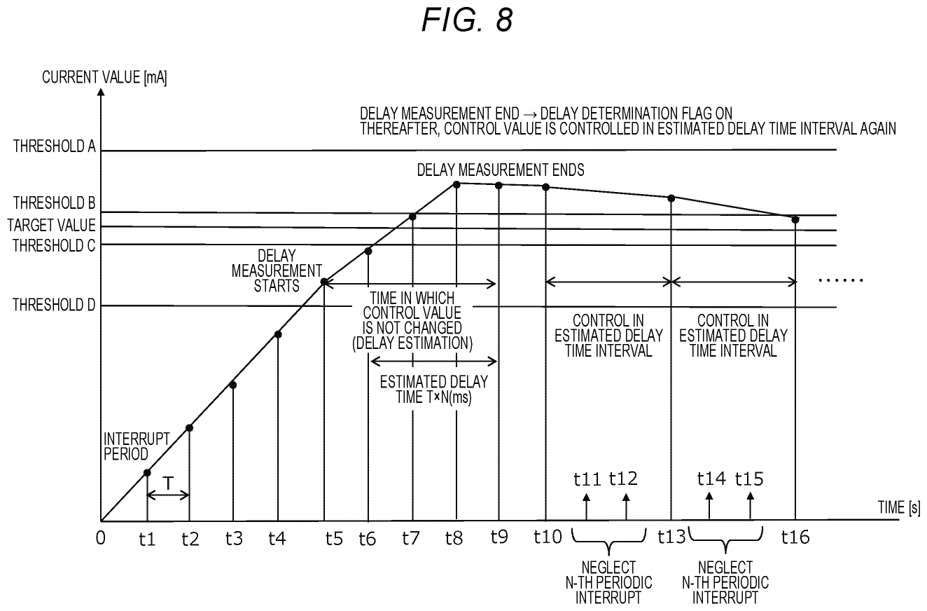

The memory 231 stores data or a program to be referred to during a process executed by the power reception side processor 230, and temporarily stores data generated during the process executed by the power reception side processor 230. The memory 231 stores, for example, a plurality of thresholds A, B, C, and D (see FIG. 8) used for controlling a delay time of an operation of the feedback system, and a target current value (see FIG. 8) suitable for charging the secondary battery 223. Hereinafter, the plurality of thresholds A, B, C, and D and the target current value may be collectively referred to as a “reference current value”.

The AD conversion unit 232 converts the charging current to the secondary battery 223 detected by the current detection unit 250 into a digital value.

The feedback system delay determination unit 233 compares the reference current value (see above) read from the memory 231 with the value of the charging current converted by the AD conversion unit 232. The feedback system delay determination unit 233 determines an operating delay of the feedback system based on a difference between the value of the charging current and the reference current value, and sends a determination result to the feedback control value determination unit 234. While measuring the operating delay, for example (see time points t5 to t9 in FIG. 8), the feedback system delay determination unit 233 sends, to the feedback control value determination unit 234, a determination result indicating that a feedback control value IA is fixed. The determination of the operating delay will be described in detail with reference to FIGS. 5 to 7.

The feedback control value determination unit 234 calculates the feedback control value IA (for example, a current value indicating a difference between the target current value and the value of the charging current converted by the AD conversion unit 232) as an example of a feedback control parameter on the basis of the determination result from the feedback system delay determination unit 233, and transmits the calculated feedback control value IA to the power supply control unit 235. Based on the determination result from the feedback system delay determination unit 233 during the measurement of the operating delay, the feedback control value determination unit 234 determines to fix the feedback control value IA to a previous calculation value. In addition, the feedback control value determination unit 234 may transmit the feedback control value IA to the information communication unit 240.

The power supply control unit 235 generates, based on the feedback control value IA from the feedback control value determination unit 234, a control signal for bringing the charging current close to the target current value, and supplies the generated control signal to the stack DC/DC power supply 221.

Next, a configuration example of the power reception side processor 230A according to the feedback control route 2 will be described with reference to FIG. 4. The feedback control route 2 performs feedback control such that a charging current to the secondary battery 223 is set to a target current value in cooperation with both the power reception device 200 serving as the secondary side and the power transmission device 100 serving as a primary side. FIG. 4 is a block diagram illustrating the configuration example of the power reception side processor 230A corresponding to the feedback control route 2. In describing FIG. 4, the same components as those illustrated in FIG. 3 are denoted by the same reference numerals, and a description thereof will be simplified or omitted, and different contents will be described. The power reception side processor 230A includes the memory 231, the AD conversion unit 232, the feedback system delay determination unit 233, a feedback control value determination unit 234A, and a power supply control unit 235A.

The feedback control value determination unit 234A calculates a feedback control value IB (for example, a current value indicating a difference between the target current value and the value of the charging current converted by the AD conversion unit 232) as an example of a feedback control parameter on the basis of a determination result from the feedback system delay determination unit 233, and transmits the calculated feedback control value IB to the information communication unit 240. Similarly to the feedback control value determination unit 234, based on the determination result from the feedback system delay determination unit 233 during the measurement of the operating delay, the feedback control value determination unit 234A determines to fix the feedback control value IB to a previous calculation value.

The power supply control unit 235A generates a control signal for approaching a predetermined current value, and supplies the generated control signal to the stack DC/DC power supply 221.

The information communication unit 240 transmits the feedback control value IB from the feedback control value determination unit 234A to the information communication unit 140 of the power transmission device 100. The information communication unit 140 receives the feedback control value IB transmitted from the information communication unit 240 of the power reception device 200 and transmits the feedback control value IB to the power transmission side processor 130.

Based on the feedback control value IB from the information communication unit 140, the power transmission side processor 130 generates a control signal for controlling the transmission power from the power transmission circuit 150, which is the primary side, in order to bring the charging current close to the target current value, and supplies the generated control signal to the power transmission circuit 150.

The power transmission circuit 150 converts the AC power from the AC power supply 110 into electric power corresponding to the control signal based on the control signal from the power transmission side processor 130, and transmits the electric power to the power reception circuit 210.

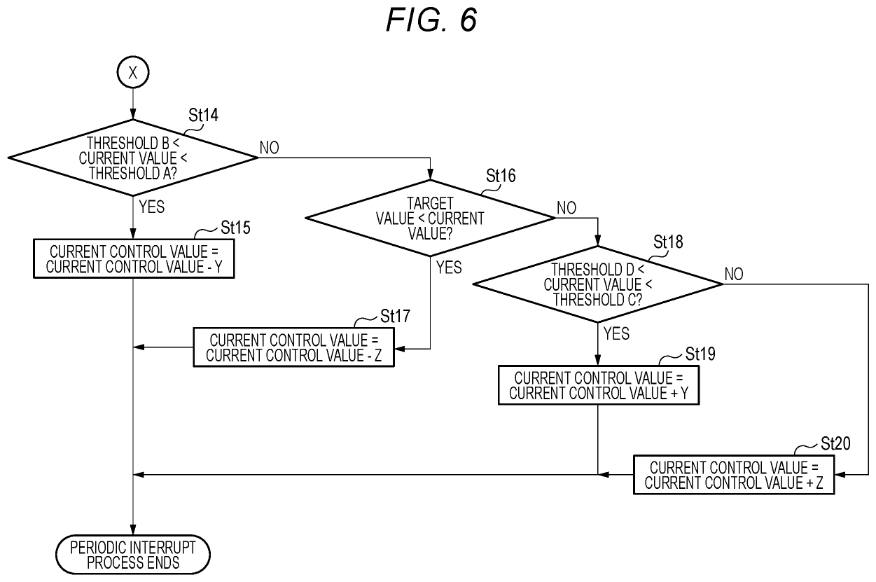

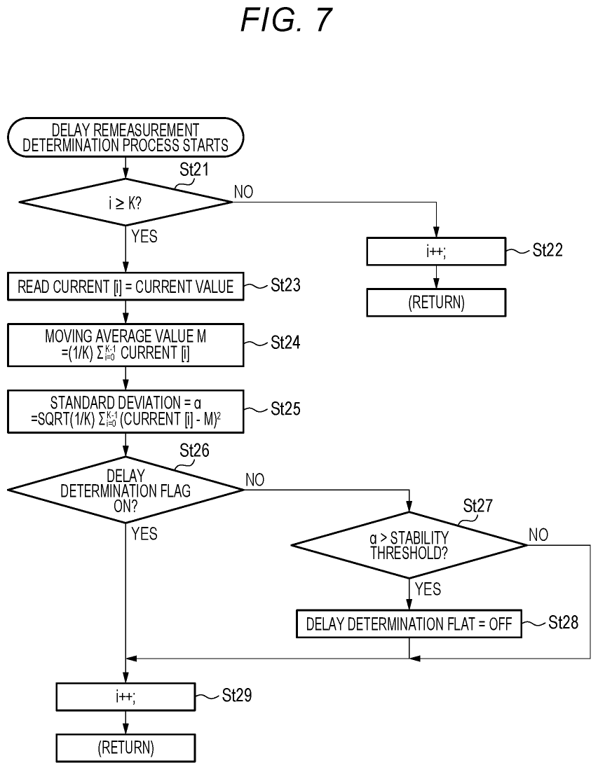

Next, an operation procedure example of periodic control of the charging current in the power reception device 200 according to the present embodiment will be described with reference to FIGS. 5 to 8. FIGS. 5 and 6 are flowcharts illustrating an example of an operation procedure of the power reception side processors 230 and 230A according to the present embodiment. FIG. 7 is a flowchart illustrating an example of an operation procedure of a delay remeasurement determination process in FIG. 5. FIG. 8 is a graph illustrating an example of transition of a current value of the charging current detected for each periodic interrupt process. Hereinafter, in order to simplify the description, a periodic interrupt process to be performed by the power reception side processor 230 will be described taking the feedback control route 1 (see FIG. 3) as an example.

In FIG. 5, the power reception side processor 230 acquires, by an output of the AD conversion unit 232, a present current value (that is, a value of the charging current) detected by the current detection unit 250 (SU). In describing FIGS. 5 to 8, the present current value acquired in step St1 may be simply referred to as the “current value”. After acquiring the present current value in step St1, the power reception side processor 230 executes the delay remeasurement determination process for determining whether it is necessary to measure a delay again (in other words, for determining whether the charging current is appropriately controlled) (St2). Details of the delay remeasurement determination process in step St2 will be described later with reference to FIG. 7.

The power reception side processor 230 determines whether this time is a timing of an N-fold periodic interrupt process (St3). When measurement of an operating delay of the feedback system is not started, N is an initial value (=1). When the measurement of the operating delay of the feedback system is completed (that is, when an estimated delay time is determined), N=(determined estimated delay time)/T. T is an execution period of the periodic interrupt process, and is, for example, 10 ms. When this time is not the timing of the N-fold periodic interrupt process (St3, NO), the periodic interrupt process of the power reception side processor 230 ends.

It should be noted that the case where this time is not the timing of the N-fold periodic interrupt process may be timings of time points t11, t12, t14, and t15 when referring to FIG. 8. As will be described later, when the estimated delay time is calculated to be T×N [ms] as the delay measurement result, the power reception side processor 230 controls the charging current for each T×N [ms]. Therefore, at the time points t11 and t12 in a period when T×N [ms] does not elapse from a time point t10, and further at the time points t14 and t15 in a period when T×N [ms] does not elapse from a time point t13, the periodic interrupt process is not executed.

On the other hand, when it is determined that this time is the timing of the N-fold periodic interrupt process (St3, YES), the power reception side processor 230 compares a plurality of thresholds A and D (see FIG. 8) read from the memory 231 with the current value acquired in step St1, and determines whether “the threshold A<the current value” or “the threshold D>the current value” is established (St4).

When the power reception side processor 230 determines that “the threshold A<the current value” or “the threshold D>the current value” is established (St4, YES), the power reception side processor 230 determines whether “the threshold A<the current value” is established (St5). When it is determined that “the threshold A<the current value” is established (St5, YES), since the present current value is significantly larger than the target current value (see FIG. 8), the power reception side processor 230 calculates a current control value (that is, the feedback control value IA) to be “the present current control value (that is, the feedback control value IA)−X” in order to approach the target current value (St6). X is a variable value of a real number (0<X), and corresponds to, for example, a difference between the present current value and the target current value. After step St6, the periodic interrupt process of the power reception side processor 230 ends.

When it is determined that “the threshold A<the current value” is not established (St5, NO), since “the threshold D>the current value” is established (see FIG. 8), the power reception side processor 230 calculates the current control value (that is, the feedback control value IA) to be “the present current control value (that is, the feedback control value IA)+X” in order to approach the target current value (St7). After step St7, the periodic interrupt process of the power reception side processor 230 ends.

When it is determined that neither “the threshold A<the current value” nor “the threshold D>the current value” is established (St4, NO), since “the threshold D<the current value<the threshold A” is established (see FIG. 8), the power reception side processor 230 determines that the current value is close to the target current value and starts the measurement of the operating delay of the feedback system, or continues the measurement of the operating delay of the feedback system when the measurement is already started (St8). In FIG. 8, the operating delay of the feedback system is started at a timing of a time point t5, and since the current value is away from the target current value from a time point 0 to a time point t4 and acquisition of delay characteristics in this time region is not necessary, the measurement of the operating delay of the feedback system is not started. In addition, while measuring the operating delay of the feedback system, the power reception side processor 230 uses the present feedback control value IA in a fixed manner (that is, fixes the feedback control value IA so that the feedback control value IA does not change) in order to further suppress the occurrence of the operating delay of the feedback system.

The power reception side processor 230 determines whether a delay determination flag stored in the memory 231 is ON (that is, whether the measurement of the operating delay of the feedback system in step St8 is ended) (St9). Whether the delay determination flag is ON or OFF is temporarily stored in the memory 231 by the power reception side processor 230. When it is determined that the delay determination flag is OFF (that is, the measurement of the operating delay of the feedback system in step St8 is not ended) (St9, NO), the power reception side processor 230 determines whether there is a difference between the current value acquired in step St1 of this periodic interrupt process and a previous current value (previous sampled value) acquired in step St1 of a previous periodic interrupt process (St10).

When it is determined that there is a difference (for example, a value in a certain range of about ±10 mA) between the current value acquired in step St1 of this periodic interrupt process and the previous current value (previous sampled value) acquired in step St1 of the previous periodic interrupt process (St10, YES), the power reception side processor 230 increments a period count flag (St11). The period count flag is a parameter counted during the measurement of the operating delay of the feedback system, and has a function of indicating how many times the estimated delay time, which is obtained as the measurement result, is the period of the periodic interrupt process. After step St11, the periodic interrupt process of the power reception side processor 230 ends.

On the other hand, when it is determined that there is no difference between the current value acquired in step St1 of this periodic interrupt process and the previous current value (previous sampled value) acquired in step St1 of the previous periodic interrupt process (St10, YES), the power reception side processor 230 sets a value of the period count flag at that time point to N (St12), and sets the delay determination flag to ON (St13). After step St13, the periodic interrupt process of the power reception side processor 230 ends. For example, referring to FIG. 8, the measurement of the operating delay of the feedback system is started at the timing of the time point t5, and the measurement of the operating delay of the feedback system is ended at the timing of the time point t9 at which it is determined that there is no difference from the previous sampled value. In this measurement, the estimated delay time that could occur in the feedback system is a product (T×N [ms]) of the period (T [ms]) of the periodic interrupt process and a value (N) of the period count flag at a measurement end timing. Therefore, from and after the time point t10 subsequent to the time point t9 at which the measurement of the operating delay of the feedback system is ended, the power reception side processor 230 executes the periodic interrupt process at each estimated delay time interval.

When it is determined that the delay determination flag is ON (that is, the measurement of the operating delay of the feedback system in step St8 is ended) (St9, YES), the power reception side processor 230 determines whether “the threshold B<the current value<the threshold A” is established, using the thresholds A and B read from the memory 231 (St14).

In FIG. 6, when it is determined that “the threshold B<the current value<the threshold A” is established (St14, YES), since the present current value is larger than the target current value (see FIG. 8), the power reception side processor 230 calculates the current control value (that is, the feedback control value IA) to be “the present current control value (that is, the feedback control value IA)−Y” in order to approach the target current value (St15). Y is a variable value of a real number (0<Y<<X), and corresponds to, for example, a difference between the present current value and the target current value. After step St15, the periodic interrupt process of the power reception side processor 230 ends.

On the other hand, when it is determined that “the threshold B<the current value<the threshold A” is not established (St14, NO), the threshold D<the current value<the threshold B is established (see FIG. 8), and the power reception side processor 230 determines whether “the target value<the current value” is established (St16). When it is determined that “the target value<the current value” is established (St16, YES), since the present current value is slightly larger than the target value (see FIG. 8), the power reception side processor 230 calculates the current control value (that is, the feedback control value IA) to be “the present current control value (that is, the feedback control value IA)−Z” in order to approach the target current value (St17). Z is a variable value of a real number (0<Z<Y<<X), and corresponds to, for example, a difference between the present current value and the target current value. After step St17, the periodic interrupt process of the power reception side processor 230 ends.

When it is determined that “the target value<the current value” is not established (St16, NO), the threshold D<the current value<the target current value is established (see FIG. 8), and the power reception side processor 230 determines whether “the threshold D<the current value<the threshold C” is established (St18). When it is determined that “the threshold D<the current value<the threshold C” is established (St18, YES), since the present current value is smaller than the target value (see FIG. 8), the power reception side processor 230 calculates the current control value (that is, the feedback control value IA) to be “the present current control value (that is, the feedback control value IA)+Y” in order to approach the target current value (St19). After step St19, the periodic interrupt process of the power reception side processor 230 ends.

On the other hand, when it is determined that “the threshold D<the current value <the threshold C” is not established (St18, NO), since the present current value is slightly smaller than the target value (see FIG. 8), the power reception side processor 230 calculates the current control value (that is, the feedback control value IA) to be “the present current control value (that is, the feedback control value IA)+Z” in order to approach the target current value (St20). After step St20, the periodic interrupt process of the power reception side processor 230 ends.

The delay remeasurement determination process illustrated in FIG. 7 is, for example, a process executed, after the measurement of the operating delay of the feedback system is ended, to check whether the control of the charging current is appropriately performed, in view of a possibility that a temporal characteristic of the operating delay of the feedback system changes, and a possibility that a delay characteristic changes according to a change in a coupling coefficient of the coil due to a positional relationship between the power transmission device 100 and the power reception device 200 being the position free in the case of the feedback control route 2. The possibility that a temporal characteristic of the operating delay of the feedback system changes is based on, for example, a fact that the impedance at the time of charging of the secondary battery 223 is a very small value, and a fact that a battery characteristic of the secondary battery 223 changes with an increase in battery voltage of the secondary battery 223 due to charging and the battery impedance changes. Specifically, the power reception side processor 230 determines whether the remeasurement of the operating delay of the feedback system is necessary, by monitoring a moving average value and a standard deviation (that is, a variation in the current value) of the current value detected by the current detection unit 250 in the delay remeasurement determination process.

In FIG. 7, the power reception side processor 230 determines whether a variable i indicating a sample number of the current value is equal to or greater than a predetermined moving average sample number K (St21). The moving average sample number K is the number of samples required for calculating the moving average value of the current value according to the formula to be described later. When it is determined that the variable i is less than the moving average sample number K (St21, NO), the power reception side processor 230 increments the variable i (St22). After step St22, the delay remeasurement determination process of the power reception side processor 230 ends, and the process of the power reception side processor 230 proceeds to step St3.

When it is determined that the variable i is equal to or greater than the moving average sample number K (St21, YES), the power reception side processor 230 reads out data of the current value (Current [i]) detected by the current detection unit 250 (St23). The power reception side processor 230 calculates a moving average value M of K current values according to Formula (1) using data of the K current values (St24). Similarly to the variable i, n represents an ordinal number of the read current value, and is a positive integer. The power reception side processor 230 uses the moving average value M calculated in step St24 to calculate a standard deviation a indicating a variation in the K current values according to Formula (2) (St25).

$$\begin{matrix}[ Formula 1 ] & \\ M = ( \frac{1}{K} ) \times {\sum }_{n = i - K + 1}^{i} ( Current [ n ] ) & ( 1 )\end{matrix}$$

$$\begin{matrix}[ Formula 2 ] & \\ α = \sqrt{( \frac{1}{K} ) \times {\sum }_{n = i - K + 1}^{i} {( Current [ n ] - M )}^{2}} & ( 2 )\end{matrix}$$

The power reception side processor 230 determines whether the delay determination flag is OFF with reference to the memory 231 (St26). When it is determined that the delay determination flag is OFF (that is, the estimated delay time is not determined) (St26, YES), the power reception side processor 230 increments the variable i (St29). After step St29, the delay remeasurement determination process of the power reception side processor 230 ends, and the process of the power reception side processor 230 proceeds to step St3.

On the other hand, when it is determined that the delay determination flag is ON (that is, the estimated delay time is determined) (St26, NO), the power reception side processor 230 determines whether the standard deviation a calculated in step St25 is larger than a predetermined stability threshold stored in the memory 231 (in other words, whether the current value to be controlled based on the feedback control value IA varies) (St27).

When the power reception side processor 230 determines that the standard deviation a is greater than the predetermined stability threshold (St27, YES), since the delay determination flag is ON and the estimated delay time is determined but the variation of the current value is large, the power reception side processor 230 regards it necessary to perform the remeasurement of the operating delay of the feedback system, and sets the delay determination flag to OFF (St28). After step St28, the process of the power reception side processor 230 proceeds to step St29.

On the other hand, when it is determined that the standard deviation a is smaller than the predetermined stability threshold (St27, NO), since the delay determination flag is ON and the estimated delay time is determined but the variation of the current value is small, the control of the charging current can be performed in a relatively stable manner, and thus the power reception side processor 230 regards it unnecessary to perform the remeasurement of the operating delay of the feedback system, and increments the variable i (St29). After step St29, the delay remeasurement determination process of the power reception side processor 230 ends, and the process of the power reception side processor 230 proceeds to step St3.

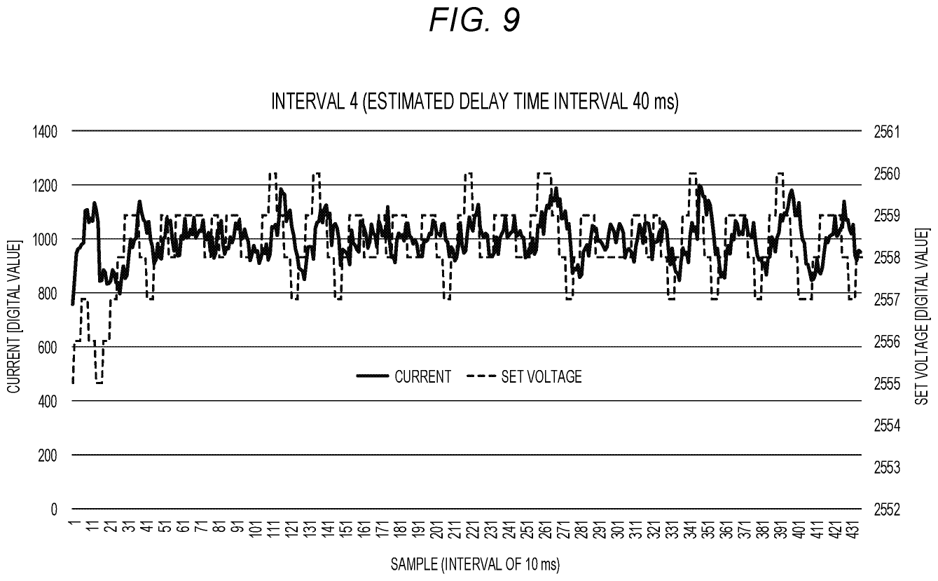

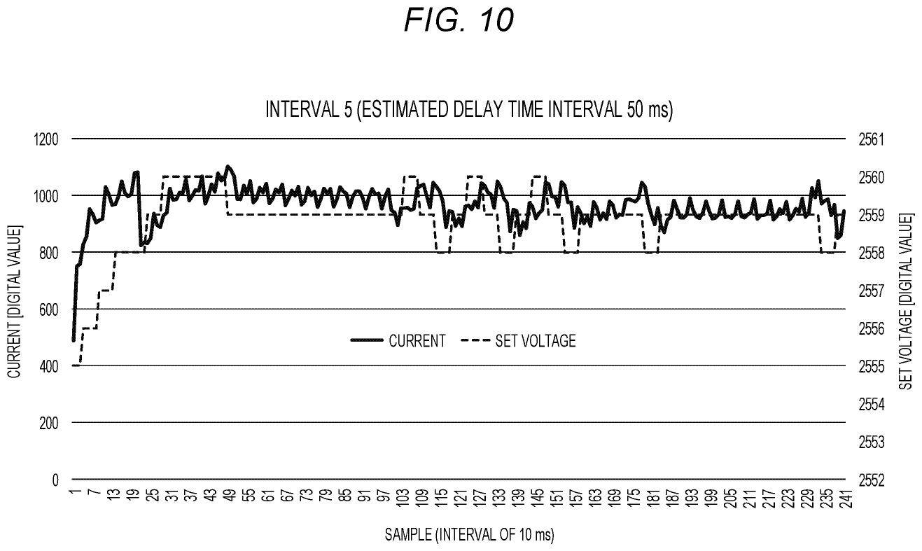

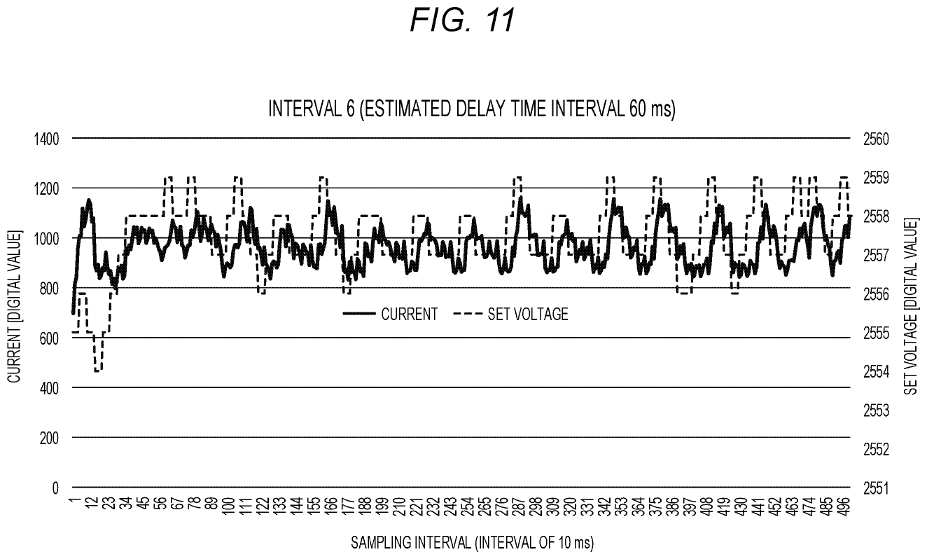

Next, an experimental result of how stability of the charging current changes when the estimated delay time is changed will be described with reference to FIGS. 9 to 11. FIG. 9 is a graph illustrating an example of an experimental result of the stability of the charging current when the estimated delay time interval is set to 40 ms. FIG. 10 is a graph illustrating an example of an experimental result of the stability of the charging current when the estimated delay time interval is set to 50 ms. FIG. 11 is a graph illustrating an example of an experimental result of the stability of the charging current when the estimated delay time interval is set to 60 ms.

In this experiment, measurement of the delay time of the feedback system (see FIG. 3 or FIG. 4) is not performed and the estimated delay time interval (that is, an execution interval of the periodic interrupt process illustrated in FIGS. 5 to 7) is a fixed value, and it is known that it is clear that the stability of the charging current changes according to the value of the estimated delay time interval that is a fixed value. For example, FIG. 9 illustrates the temporal transition of the charging current when the estimated delay time interval is set to 40 ms, FIG. 10 illustrates the temporal transition of the charging current when the estimated delay time interval is set to 50 ms, and FIG. 11 illustrates the temporal transition of the charging current when the estimated delay time interval is set to 60 ms. In the experiment, a battery simulator (21 cells) is used for evaluation of the charging current, and the stack DC/DC power supply 221 of the power supply unit 220 of the power reception device 200 is used for a three-stack power supply. Referring to FIGS. 9 to 11, it is known that, in this experiment, the charging current transitions most stably when the estimated delay time interval is 50 ms.

As described above, the underwater power supply system 1000 according to the present embodiment includes the power transmission device 100 and the power reception device 200 that is capable of moving underwater. The power transmission device 100 includes the power transmission coil CLA configured to transmit electric power to the power reception device 200 via a magnetic field, and the power transmission side processor 130 configured to control electric power from a power transmission power supply (for example, the AC power supply 110) and supply the electric power to the power transmission coil CLA. The power reception device 200 includes: the power reception coil CLB configured to receive electric power from the power transmission coil CLA; a power reception power supply (for example, the power supply unit 220) including the stack DC/DC power supply 221 that is a plurality of general-purpose power supply components (for example, a power supply circuit in which a plurality of DC/DC converters are combined), and a storage battery (for example, the secondary battery 223), and configured to charge the storage battery based on the electric power received by the power reception coil CLB and based on the plurality of general-purpose power supply components; the power reception side processor 230A configured to periodically control a charging current to the storage battery; and a current sensor (for example, the current detection unit 250) configured to detect the charging current. When the power reception side processor 230A determines that a value of the detected charging current is a current value outside a predetermined range (for example, a range from the threshold D to the threshold A), the power reception side processor 230A calculates a feedback control parameter (for example, the feedback control value IB) to the power transmission power supply based on a difference between the value of the charging current and a target current value, and transmits the feedback control parameter to the power transmission side processor. The power transmission side processor controls electric power from the power transmission power supply based on the feedback control parameter.

Accordingly, when the stack DC/DC power supply 221 in which a plurality of general-purpose power supply components are combined is adopted in the power reception device 200, the underwater power supply system 1000 can stably control charging of the storage battery (for example, the secondary battery 223) following an operating delay of the feedback system in the feedback control route 2 between the power reception device 200 capable of moving underwater and the power transmission device 100.

In addition, the underwater power supply system 1000 according to the present embodiment includes the power transmission device 100 and the power reception device 200 that is capable of moving underwater. The power transmission device 100 includes the power transmission coil CLA configured to transmit electric power to the power reception device 200 via a magnetic field, and the power transmission side processor 130 configured to control electric power from a power transmission power supply (for example, the AC power supply 110) and supply the electric power to the power transmission coil CLA. The power reception device 200 includes: the power reception coil CLB configured to receive electric power from the power transmission coil CLA; a power reception power supply (for example, the power supply unit 220) including a plurality of general-purpose power supply components (for example, a power supply circuit in which a plurality of DC/DC converters are combined), and a storage battery (for example, the secondary battery 223), and configured to charge the storage battery based on the electric power received by the power reception coil CLB and based on the plurality of general-purpose power supply components; the power reception side processor 230 configured to periodically control a charging current to the storage battery; and a current sensor (for example, the current detection unit 250) configured to detect the charging current. When the power reception side processor 230 determines that a value of the detected charging current is a current value outside a predetermined range (for example, a range from the threshold D to the threshold A), the power reception side processor 230 calculates a feedback control parameter (for example, the feedback control value IA) to the power reception power supply based on a difference between the value of the charging current and a target current value. The power reception power supply controls the charging current to the storage battery based on the feedback control parameter to charge the storage battery.

Accordingly, when the stack DC/DC power supply 221 in which a plurality of general-purpose power supply components are combined is adopted in the power reception device 200, the underwater power supply system 1000 can stably control charging of the storage battery (for example, the secondary battery 223) following an operating delay of the feedback system in the feedback control route 1 between the power reception device 200 capable of moving underwater and the power transmission device 100.

When it is determined that the value of the detected charging current is a current value within the predetermined range, the power reception side processors 230 and 230A start estimation of a delay time of an operation occurring in a feedback control system of the charging current, and set the feedback control parameter to a fixed value until the estimation of the delay time is ended. Accordingly, the power reception side processors 230 and 230A can start measurement of the operating delay of the feedback system when the operating delay of the feedback system becomes a value close to the target current value at which the operating delay of the feedback system is likely to occur depending on the charging current, and can suppress a variation in the charging current during the measurement since the feedback control parameter is fixed during the measurement.

When it is determined that a difference between a value of the charging current detected previously and a latest value of the detected charging current is less than a predetermined value, the power reception side processors 230 and 230A end the estimation of the delay time. Accordingly, the power reception side processors 230 and 230A can determine that transition of the charging current is stabilized, based on a determination result that the difference between the value of the charging current detected previously and the latest value of the detected charge current is less than the predetermined value, and can appropriately end the estimation (measurement) of the delay time.

The power reception side processors 230 and 230A calculate the feedback control parameter for each estimated delay time interval after the estimation of the delay time is ended. Accordingly, the power reception side processors 230 and 230A can suppress the periodic interrupt process from being performed more than necessary, and can adaptively determine whether the transition of the charge current is stable.

The power transmission device 100 further includes a power transmission side communication unit (for example, the information communication unit 140). The power reception device 200 further includes a power reception side communication unit (for example, the information communication unit 240). The power reception side communication unit transmits the feedback control parameter to the power transmission side communication unit. Accordingly, in the feedback control 1, data communication between the power transmission device 100 and the power reception device 200 can be simplified.

Although various embodiments have been described above with reference to the drawings, it is needless to say that the present disclosure is not limited to such examples. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the various embodiments described above may be freely combined without departing from the gist of the invention.

In the present embodiment described above, the power reception device 200 may be a power generator or the like installed on the sea bottom. In this case, the power reception device 200 is fixedly installed underwater. As described above, when the power reception device 200 is a structure fixedly installed on the sea bottom and it is difficult to move the structure to charge the structure, the power transmission device 100 approaches the power reception device 200, so that the power transmission efficiency under the water can also be improved and the charging can also be performed.

In the present embodiment described above, regarding arrangement direction, the power transmission coil CLA and the plurality of relay coils CLC are arranged horizontally (horizontal direction) undersea, and may be arranged vertically (vertical direction). In a case of vertical arrangement, surfaces of the power transmission coil CLA and the relay coil CLC are substantially parallel to the water surface. In the case of vertical arrangement, the power reception coils CLB mounted on an AUV 800 may be mounted vertically so as to match a magnetic field direction. That is, surfaces of the power reception coil CLB may be substantially parallel to the water surface. In a case of a power transmission coil structure in which the power transmission coil CLA and the relay coil CLC are connected via a coupling body, even when the power transmission coil structure is disposed vertically, the underwater sailing body 70 may enter and exit in the horizontal direction with respect to the power transmission coil. On the other hand, in a case of a power transmission coil in which the power transmission coil CLA and the relay coil CLC are wound around the bobbin bn, when the power transmission coil is arranged vertically, the underwater sailing body 70 may enter an inside of the power transmission coil from openings of the bobbin bn positioned at an upper end and a lower end of the bobbin bn.

The present application is based on Japanese Patent Application No. 2020-183275 filed on Oct. 30, 2020, the contents of which are incorporated herein by reference.

### INDUSTRIAL APPLICABILITY

The present disclosure is useful as an underwater power supply system and a power reception device that stably control charging of a storage battery built in a power reception system following an operating delay of a feedback system when a stack DC/DC power supply is employed in the power reception system.

### REFERENCE SIGNS LIST

50 ship

70 underwater sailing body

100 power transmission device

110 AC power supply

120 ADC

130 power transmission side processor

140, 240 information communication unit

150 power transmission circuit

151 driver

152, 212 resonance circuit

153, 211 matching circuit

200 power reception device

210 power reception circuit

211 rectifier circuit

220 power supply unit

221 stack DC/DC power supply

222 charging control circuit

223 secondary battery

230 power reception side processor

231 memory

232 AD conversion unit

233 feedback system delay determination unit

234, 234A feedback control value determination unit

235 power supply control unit

250 current detection unit

1000 underwater power supply system

CLA power transmission coil

CLB power reception coil

1. An underwater power supply system comprising:
a power transmission device; and
a power reception device configured to be capable of moving underwater, wherein
the power transmission device includes
a power transmission coil configured to transmit electric power to the power reception device via a magnetic field, and
a power transmission side processor configured to control the electric power from a power transmission power supply and supply the electric power to the power transmission coil,
the power reception device includes
a power reception coil configured to receive electric power from the power transmission coil,
a power reception power supply including a plurality of general-purpose power supply components and a storage battery, and configured to charge the storage battery based on the electric power received by the power reception coil and based on the plurality of general-purpose power supply components,
a power reception side processor configured to periodically control a charging current to the storage battery, and
a current sensor configured to detect the charging current,
when it is determined that a value of the detected charging current is a current value outside a predetermined range, the power reception side processor calculates a feedback control parameter to the power transmission power supply based on a difference between the value of the charging current and a target current value, and transmits the feedback control parameter to the power transmission side processor, and
the power transmission side processor controls electric power from the power transmission power supply based on the feedback control parameter.

2. An underwater power supply system comprising:
a power transmission device; and
a power reception device configured to be capable of moving underwater, wherein the power transmission device includes
a power transmission coil configured to transmit electric power to the power reception device via a magnetic field, and
a power transmission side processor configured to control the electric power from a power transmission power supply and supply the electric power to the power transmission coil,
the power reception device includes
a power reception coil configured to receive electric power from the power transmission coil,
a power reception power supply including a plurality of general-purpose power supply components and a storage battery, and configured to charge the storage battery based on the electric power received by the power reception coil and based on the plurality of general-purpose power supply components,
a power reception side processor configured to periodically control a charging current to the storage battery, and
a current sensor configured to detect the charging current,
when it is determined that a value of the detected charging current is a current value outside a predetermined range, the power reception side processor calculates a feedback control parameter to the power reception power supply based on a difference between the value of the charging current and a target current value, and
the power reception power supply controls the charging current to the storage battery based on the feedback control parameter to charge the storage battery.

3. The underwater power supply system according to claim 1 or 2, wherein
when it is determined that the value of the detected charging current is a current value within the predetermined range, the power reception side processor starts estimation of a delay time of an operation occurring in a feedback control system of the charging current, and sets the feedback control parameter to a fixed value until the estimation of the delay time is ended.

4. The underwater power supply system according to claim 3, wherein
when it is determined that a difference between a value of the charging current detected previously and a latest value of the detected charging current is less than a predetermined value, the power reception side processor ends the estimation of the delay time.

5. The underwater power supply system according to claim 4, wherein
the power reception side processor calculates the feedback control parameter for each estimated delay time interval after the estimation of the delay time is ended.

6. The underwater power supply system according to claim 1, wherein
the power transmission device further includes a power transmission side communication unit,
the power reception device further includes a power reception side communication unit, and
the power reception side communication unit transmits the feedback control parameter to the power transmission side communication unit.

7. A power reception device that is configured to be capable of moving underwater and that receives electric power transmitted from a power transmission device including a power transmission coil, the power reception device comprising:
a power reception coil configured to receive electric power from the power transmission coil;
a power reception power supply including a plurality of general-purpose power supply components and a storage battery, and configured to charge the storage battery based on the electric power received by the power reception coil and based on the plurality of general-purpose power supply components;
a power reception side processor configured to periodically control a charging current to the storage battery; and
a current sensor configured to detect the charging current,
wherein when it is determined that a value of the detected charging current is a current value outside a predetermined range, the power reception side processor calculates a feedback control parameter to a power transmission power supply based on a difference between the value of the charging current and a target current value, and instructs, to the power transmission device, power control from the power transmission power supply based on the feedback control parameter.

8. A power reception device that is configured to be capable of moving underwater and that receives electric power transmitted from a power transmission device including a power transmission coil, the power reception device comprising:
a power reception coil configured to receive electric power from the power transmission coil;
a power reception power supply including a plurality of general-purpose power supply components and a storage battery, and configured to charge the storage battery based on the electric power received by the power reception coil and based on the plurality of general-purpose power supply components;
a power reception side processor configured to periodically control a charging current to the storage battery; and
a current sensor configured to detect the charging current,
wherein when it is determined that a value of the detected charging current is a current value outside a predetermined range, the power reception side processor calculates a feedback control parameter to the power reception power supply based on a difference between the value of the charging current and a target current value, and
wherein the power reception power supply controls the charging current to the storage battery based on the feedback parameter to charge the storage battery.
